(19) United States
(12) Patent Application Publication
(10) Pub. No.: US 2006/0095255 A1
(43) Pub. Date: May 4, 2006

(54) Pitch conversion method for reducing complexity of transcoder

(76) Inventors: Eung-Don Lee, Daejon (KR); Jong-Mo Sung, Daejon (KR); Do-Young Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/261,348

(22) Filed: Oct. 27, 2005

(30) Foreign Application Priority Data
Nov. 2, 2004 (KR) 10-2004-0088460

(51) Int. Cl. G10L 11/04

(52) U.S. Cl. 704/207

(57) ABSTRACT

The present invention provides a pitch conversion method for reducing complexity of a transcoder for optimizing a speech quality and a complexity using characteristics of encoder in a transmitter and decoder in a receiver. The pitch conversion method for reducing complexity of the transcoder includes: classifying plural frames transmitted from a transmitter into frame units, each having a predetermined number of frame; recognizing a transmitting pitch included in the frame units; deciding a pitch estimation range based on the transmitting pitch; estimating at least one candidate pitch in the pitch estimation range by using a open-loop pitch search operation; and searching a final pitch around the estimated candidate pitch by using a closed-loop pitch search operation.

### FIELD OF INVENTION

The present invention relates to a pitch conversion method of a transcoder; and, more particularly, to a pitch conversion method for reducing a complexity of a transcoder and a computer-readable recording medium storing a program for optimizing a speech quality and the complexity using characteristics of encoder in a transmitter and decoder in a receiver.

### DESCRIPTION OF PRIOR ART

As request of wire and wireless services is enlarged, a mobile communication technology and a data communication technology are developed. Also, an International Mobile Telecommunications-2000 (IMT-2000) for providing a multimedia service can expand an internet service. In additional, if interworking between wire and wireless communication networks is gone broadly and vigorously, a lot of wire communication networks can be gradually replaced with wireless communication networks.

For enabling communication between different type networks, e.g., a VOIP terminal and an IMT-2000 terminal, it is necessary to provide a network switchboard including a encoder and a decoder which are individually standardized with the different type networks. For example, at a speech signal transmission between a mobile communication network using a speech encoder, e.g., an enhanced variable rate codec (EVRC) or an Adaptive Multi-Rate (AMR), and a VOIP network using a speech encoder, e.g., G.732.1 or G.729, it is inevitable to perform at least two times encoding/decoding operations because of different type speech encoders. Herein, a system performing double encoding/decodings is considered as a tandom type structure.

In the tandom type structure, bitstreams generated from one encoder is decoded first and then encoded by the other encoder. Because of above double encoding operations, a speech quality reduction, a high complexity and a transition delay time increase are occurred.

To solve above problems, the network switchboard must embed a transcoding algorithm for converting bitstreams generated by a source encoder into bitstreams of target encoder, not a tandom algorithm. Herein, a network switchboard embedding a transcoding algorithm is called a transcoder.

The transcoder searches an open-loop pitch of a receiver throughout an open-loop pitch search operation, with a low complexity and without a speech quality deterioration. Herein, a complexity is defined as an operation amount for searching a pitch. In the conventional method, a pitch of a transmitter is used as that of a receiver or determined by a cutting method where a predetermined pitch of transmitter over a maximum pitch of receiver is deleted (cutted). Further, a conventional pitch smoothing method is used if there is a remarkable difference between a pitch of transmitter and a pitch of receiver.

The pitch smoothing method may search an open-loop pitch with a low complexity and without speech quality deterioration. Moreover, a complexity of the pitch smoothing method depends on a difference between a pitch of transmitter and a pitch of receiver corresponding to a previous frame.

However, a result throughout a lot of experiments shows a remarkable difference in the voiceless range which generally importance of the pitch is relatively low. Meanwhile, there is a problem that high complexity is required for a speech encoding operation even though the pitch does not affect to a speech quality in the voiceless range.

A target signal is recovered by parameters transmitted from a transmitter for searching the open-loop pitch in the transcoder. Therefore, the target signal has the same period with a closed-loop pitch generated from the transmitter. When an encoder of the transmitter and an encoder of a receiver have a same frame size, the closed-loop pitch of the transmitter can be used as an open-loop pitch of the receiver without any conversion.

However, referring to a speech encoder such as an AMR (Adaptive Multi-Rate) and a G.723.1, the G.723.1 has a 30 ms frame size and the AMR has a 20 ms frame size. Therefore, a transcoder for overcoming a difference between a frame size and a subframe size should embed a compensation method for compensating the difference in order to use a closed-loop pitch of the transmitter as a open-loop pitch of the receiver.

### SUMMARY OF INVENTION

It is, therefore, an object of the present invention to provide a pitch conversion method for reducing a complexity of a transcoder and a computer-readable recording medium for storing a program for optimizing a speech quality and a complexity based on characteristics of encoder in a transmitter and decoder in receiver.

In accordance with an aspect of the present invention, there is provided a pitch conversion method for reducing complexity of a transcoder, the method including: classifying plural frames transmitted from a transmitter into frame units, each having a predetermined number of frame; recognizing a transmitting pitch included in the frame units; deciding a pitch estimation range based on the transmitting pitch; estimating at least one candidate pitch in the pitch estimation range by using a open-loop pitch search operation; and searching a final pitch around the estimated candidate pitch by using a closed-loop pitch search operation.

### BRIEF DESCRIPTION OF THE DRAWINGS

The above and other objects and features of the present invention will become apparent from the following description of preferred embodiments taken in conjunction with the accompanying drawings, in which:

FIG. 1 is a block diagram showing a speech transcoder system in accordance with the present invention;

FIGS. 2A to 2B are block diagrams depicting a tandem algorithm and a transcoder for a speech transcoding operation in accordance with an embodiment of the present invention;

FIGS. 3A to 3B illustrate a pitch conversion operation for reducing a complexity in accordance with an embodiment of the present invention;

FIGS. 4A to 4B are graphs showing a variation of a speech quality in accordance with an embodiment of the present invention;

FIGS. 5A to 5B are graphs showing a variation of pitch according to an open-loop pitch search method of the transcoder;

FIG. 6A is a table showing a complexity according to the open-loop pitch search method of the transcoder;

FIGS. 6B to 6C are graphs showing a variation of a speech quality according to the open-loop pitch search method of the transcoder; and

FIGS. 7A to 7B are flowcharts describing a pitch conversion method for reducing a complexity of the transcoder in accordance with an embodiment of the present invention.

### DETAILED DESCRIPTION OF INVENTION

Hereinafter, a pitch conversion method for reducing a complexity of a transcoder in accordance with the present invention will be described in detail referring to the accompanying drawings.

FIG. 1 is a block diagram showing a speech transcoder system in accordance with the present invention.

As shown, the speech transcoder 11 has a direct conversion of speech bitstreams transmitted between an A speech encoder 10 and a B speech decoder 20. The speech transcoder 11 includes a LSP mapping operation 12, an adaptive codebook mapping operation 13, and fixed codebook mapping operation 14. The present invention is applied to the adaptive codebook mapping operation 13.

Generally, the adaptive codebook mapping operation (a pitch search operation) includes an open-loop pitch search operation and a closed-loop pitch search operation in a speech transcoder of a Code Excited Linear Prediction (CELF) algorithm.

In the adaptive codebook mapping operation, candidate pitches are first found by the open-loop pitch search operation; and then a final pitch is around the candidate pitches found by the closed-loop pitch search operation. However, the pitch conversion method in accordance with the present invention performs the open-loop pitch search operation in a predetermined pitch estimation range, not a full pitch search range. Herein, the pitch estimation range for the open-loop pitch search operation in the B speech decoder 20 is decided based on a final pitch transmitted from the A speech encoder 10.

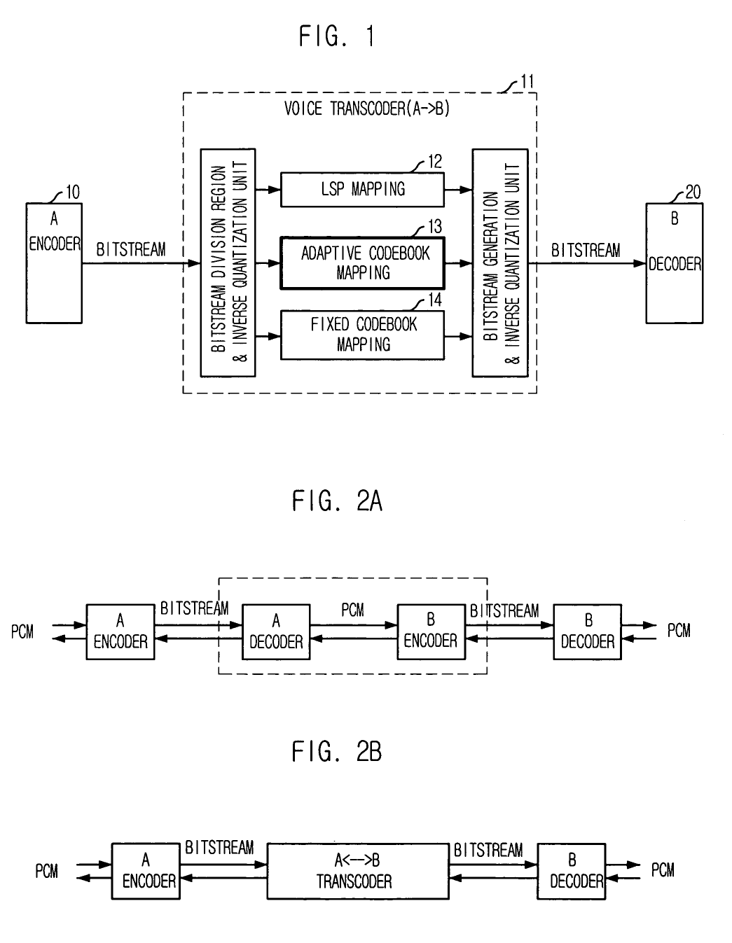

FIGS. 2A to 2B are block diagrams depicting a tandem algorithm and a transcoder for a speech transcoding operation in accordance with an embodiment of the present invention.

FIG. 2A shows the tandem algorithm; and FIG. 2B shows the transcoder for the speech transcoding operation.

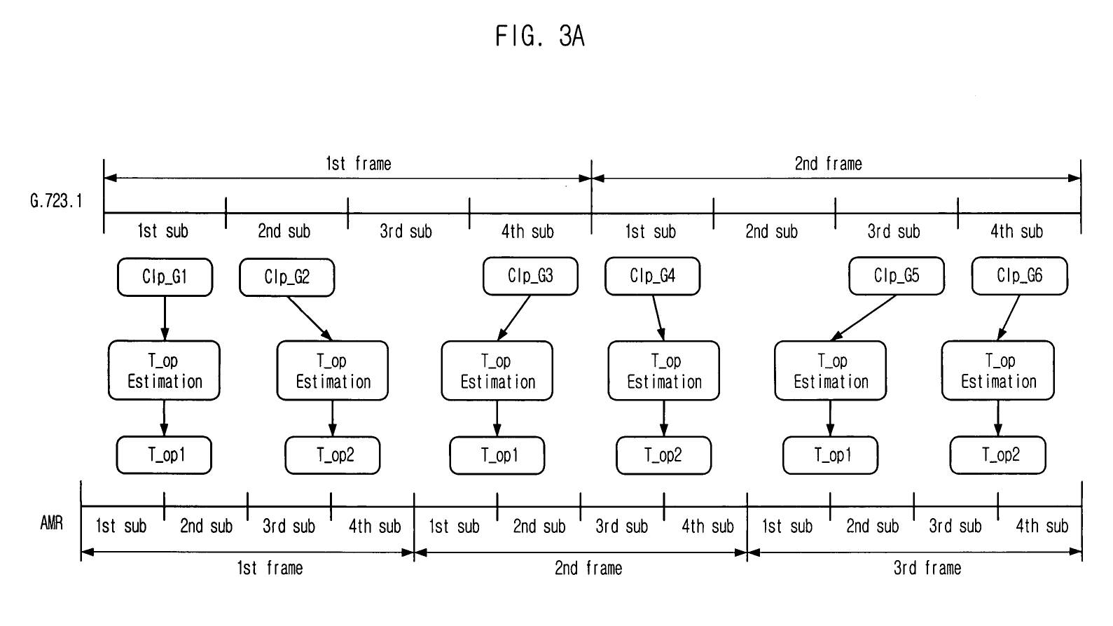

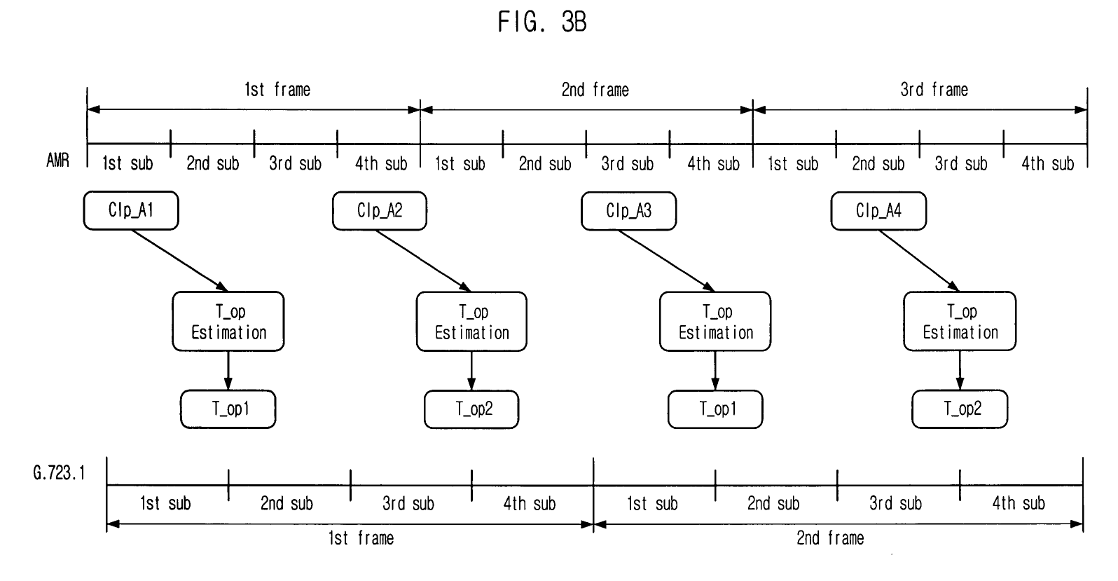

FIGS. 3A to 3B illustrate a pitch conversion operation for reducing a complexity in accordance with an embodiment of the present invention.

As shown, a pitch conversion between an AMR and a G.723.1 shows that a close-loop pitch search operation of the G.723.1 use a bigger window than a closed-loop pitch search operation of the AMR. Meanwhile, a pitch of the G.723.1 is more reliable than that of the AMR because the G.723.1 decides the pitch by using a lot of samples. A boundary of pitch estimation range of the pitch conversion in accordance with the present invention is determined based on reliabilities of the AMR and the G723.

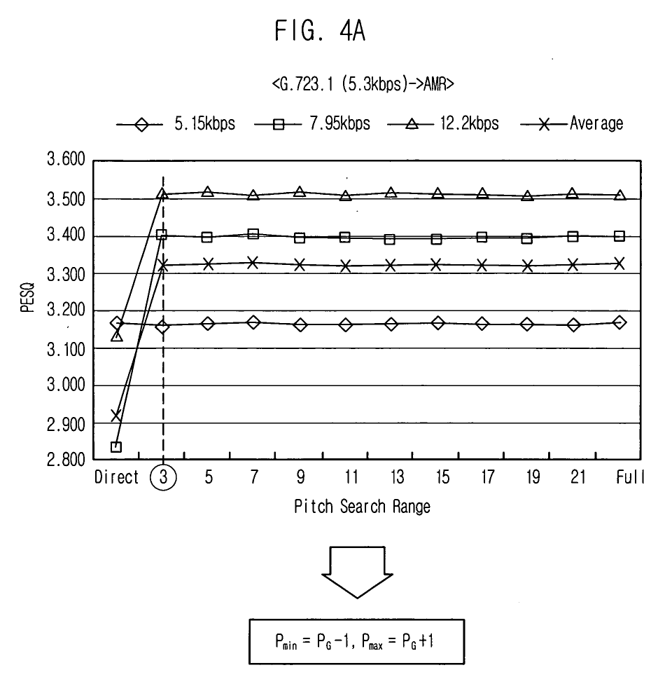

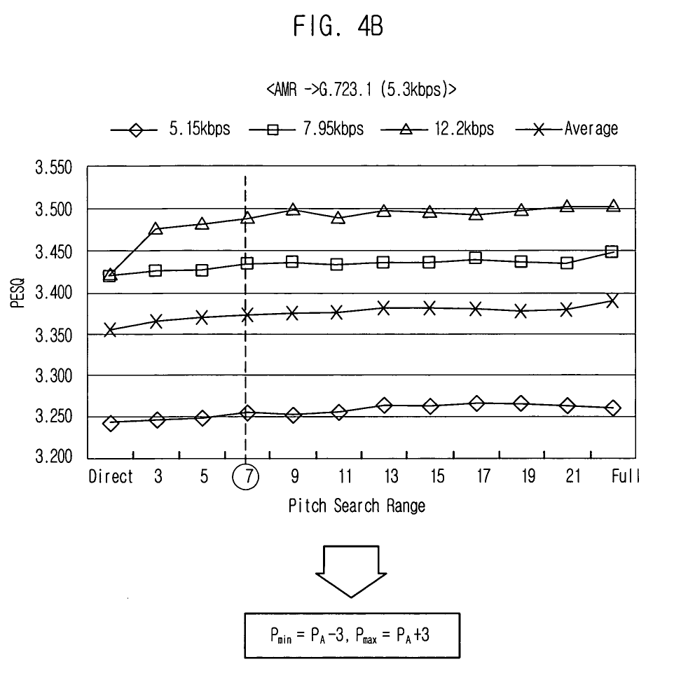

FIGS. 4A to 4B are graphs showing a variation of a speech quality in accordance with an embodiment of the present invention.

As shown, if transcoding is performed from a G.723.1 to an AMR by using a pitch of the AMR as that of the G.723.1 without any conversion, i.e., a direct mapping, there is a lot of speech quality reduction. Because the pitch of the G.723.1 is more reliable than that of the AMR, a 3-sample searching operation does not degrade a speech quality rather than a total range searching operation. Herein, the N-sample searching operation is an open-loop pitch search operation within a predetermined range, i.e., continuous N samples including a pitch of the transmitter.

On the contrary, referring to a variation of speech quality based on a pitch search range of the transcoder, in a pitch conversion from the AMR to the G.723.1, the pitch search range should be increased for improving the speech quality because the AMR uses a lower reliability than the G.723.1. However, it is meaningless for improving the speech quality that more than 7 samples are used in the pitch conversion.

According to the speech quality and a complexity, a boundary of pitch estimation range of the pitch conversion method in accordance with the present invention of transcoding algorithm between the G.723.1 and the AMR is decided as following equation 1.
Pₘᵢₙ=P_{G}−1, Pₘₐₓ=P_{G}+1, case: G.723.1 to AMR
Pₘᵢₙ=P_{A}−3, Pₘₐₓ=P_{A}+3, case: AMR to G.723.1 [Equation 1]

Herein, P_{G} is a pitch transmitted from the G723.1; and P_{A} is a pitch transmitted from the AMR.

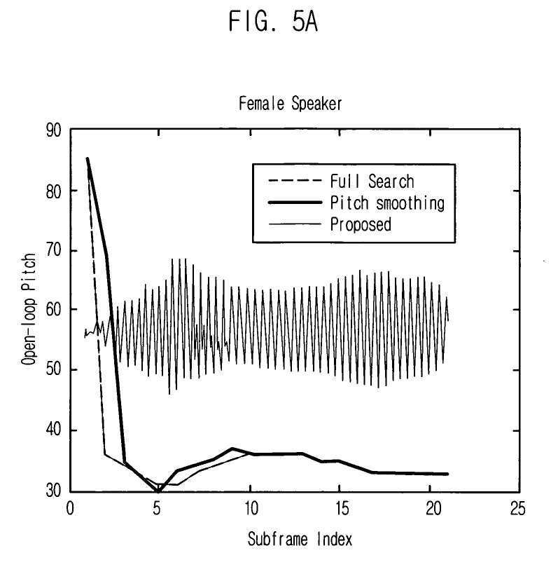

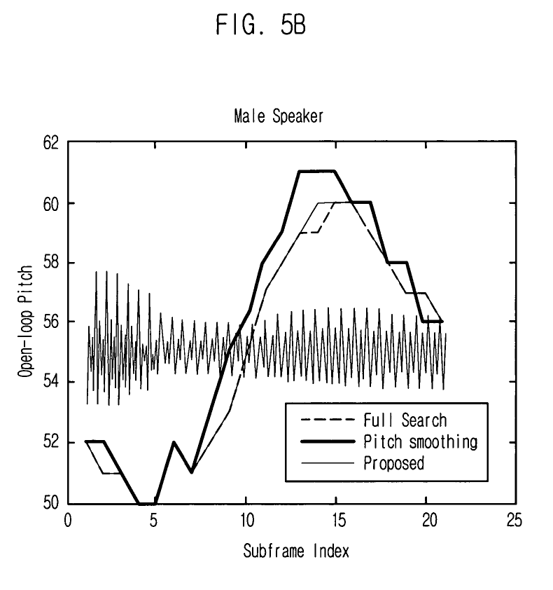

FIGS. 5A to 5B are graphs showing a variation of pitch according to an open-loop pitch search method of the transcoder.

As shown, “Full Search” represents a total range search method having a high complexity; “Pitch smoothing” represents a conventional pitch smoothing method; and “Proposed” represents a modified fast pitch search method (a pitch conversion method) in accordance with the present invention.

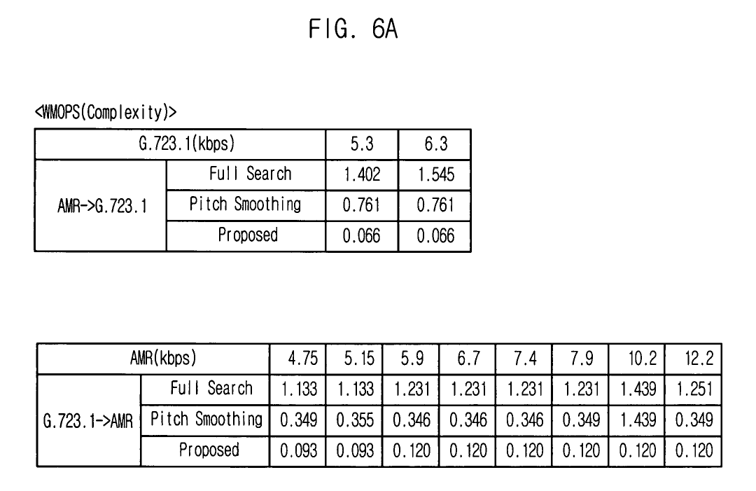

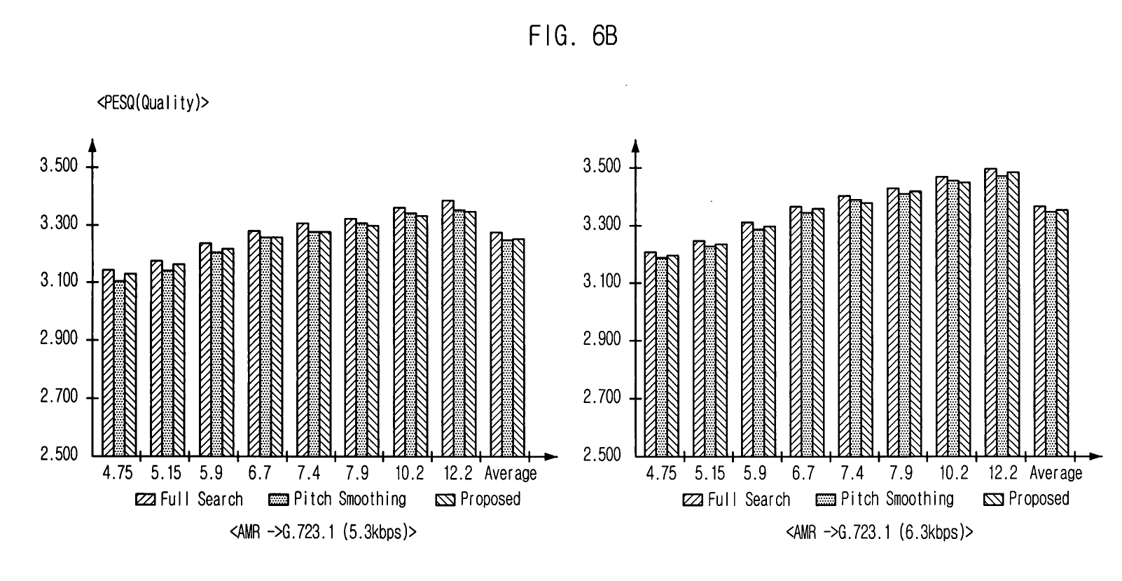

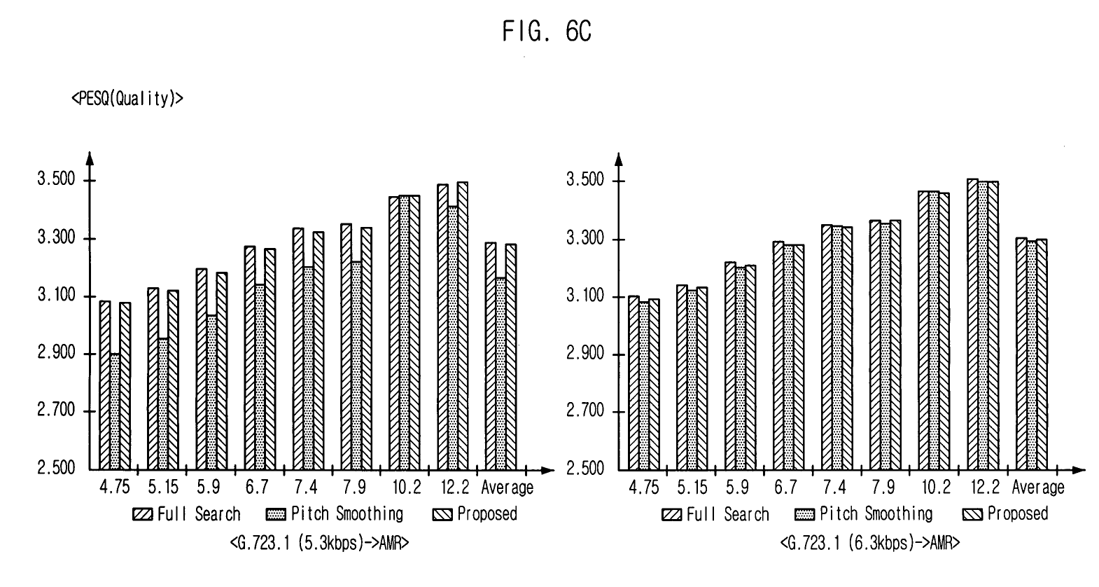

FIG. 6A is a table showing a complexity according to the open-loop pitch search method of the transcoder.

FIGS. 6B to 6C are graphs showing a variation of speech quality according to the open-loop pitch search method of the transcoder.

As shown in FIGS. 6A, the modified fast pitch conversion method in accordance with the present invention can reduce a complexity as compared with the conventional pitch smoothing method, and reduce a complexity to at least 92% as compared with the total range search method.

In addition, as shown in FIGS. 6B to 6C, the modified fast pitch conversion method in accordance with the present invention can improve a speech quality, as compared with the conventional pitch smoothing method. Moreover, the present invention has no speech quality reduction, as compared with the total range search method having a high complexity.

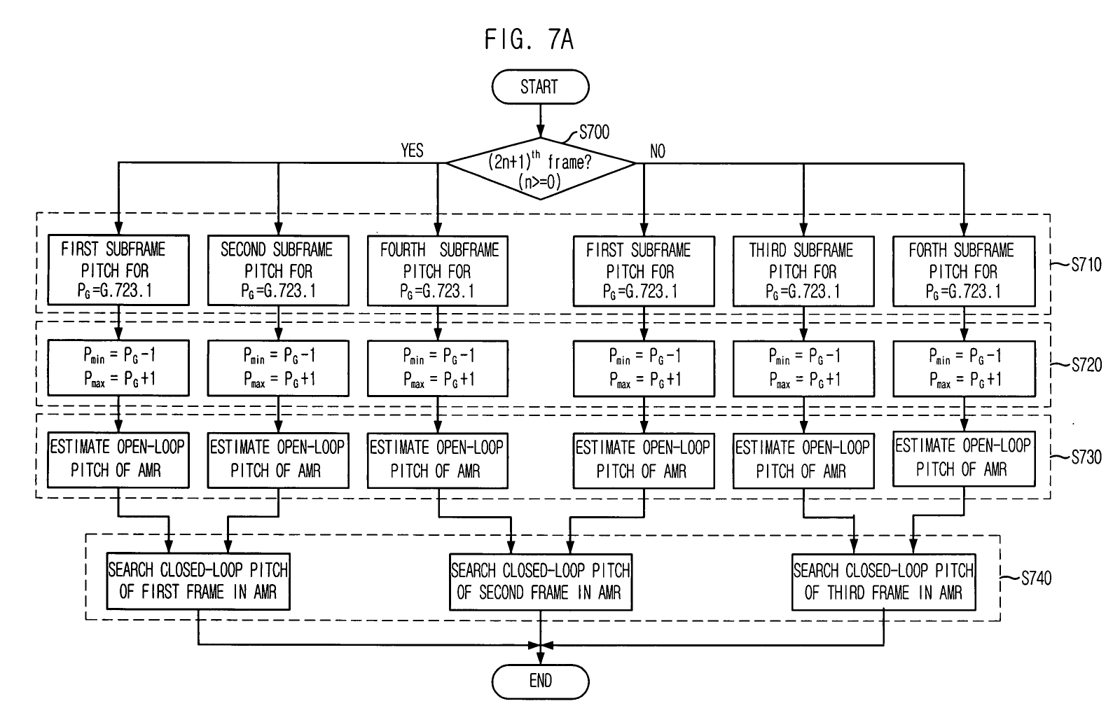

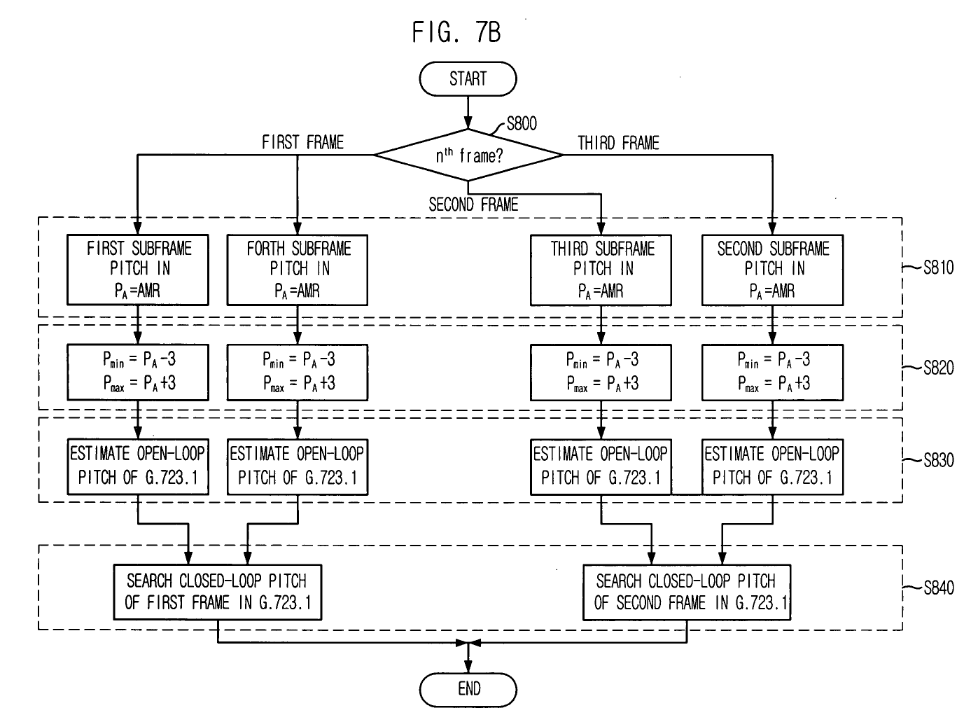

FIGS. 7A to 7B are flowcharts describing a pitch conversion method for reducing a complexity of the transcoder in accordance with an embodiment of the present invention.

FIG. 7A describes an adaptive codebook mapping operation from a G.723.1 to an AMR and FIG. 7B depicts the adaptive codebook mapping operation from the AMR to the G.723.1.

As shown, a pitch conversion method (adaptive codebook mapping operation) in accordance with the present invention includes classifying plural frames transmitted from a transmitter into frame units, each having a predetermined number of frame at each step S700 and S800, recognizing a transmitting pitch included in the frame units at each step S710 and S810, deciding a pitch estimation range based on the transmitting pitch at each step S720 and S820, estimating at least one candidate pitch in the pitch estimation range by using a open-loop pitch search operation at each step S730 and S830, and searching a final pitch around the estimated candidate pitch by using a closed-loop pitch search operation at each step S740 and S840.

The pitch conversion method for reducing a complexity of the transcoder in accordance with the present invention will be described later in detail.

At step S700, different size of each frame is considered because a G.723.1 is encoded as 30 ms period and an AMR is encoded as 20 ms period. Therefore, plural frames of the 723.1 can be divided into each two frames converted into a format of the AMR. That is, each two frames have a first frame (1,3,5, . . . , 2n+1) and a second frame (2,4,6, . . . , 2n), each having 4 subframes.

A first subframe, a second subframe and a fourth frame are selected in the first frame; and a first subframe, a third subframe and a fourth subframe are selected in the second frame.

At step S710, a transmitting pitch transmitted from the transmitter is determined as P_{G} for each selected subframe.

At step S720, a maximum value and a minimum value of a pitch estimation range are decided based on the transmitting pitch.

At step S730, at least one candidate pitch in the pitch estimation range is estimated by using an open-loop pitch search operation of the AMR for each selected subframe. That is, six candidate pitch groups are estimated.

At step S740, a final pitch is searched around the estimated candidate pitch by using a closed-loop pitch search operation of the AMR for each subframe in the AMR. In detail, the first candidate pitch group and the second candidate pitch group are selected to search for each subframe in a first frame of the AMR, the third candidate pitch group and the fourth candidate pitch group are selected to search for each subframe in a second frame of the AMR, and the fifth candidate pitch group and the fourth candidate pitch group are selected to search for each subframe in a third frame of the AMR.

At step S800, different size of each frame is considered because the G.723.1 is encoded as 30 ms period and the AMR is encoded as 20 ms period same as the step S700. Therefore, the plural frames of the AMR can be divided into each three frames converted into a format of the G.723.1.

That is, each three frames have a first frame (1,4,7, . . . , 3n+1), a second frame (2,5,8, . . . , 3n+2) and a third frame (3,6,9, . . . , 3n), each having 4 subframes.

A first subframe and a fourth frame are selected in the first frame, and a third subframe is selected in the second frame, and the second subframe is selected in the third frame.

At step S810, a transmitting pitch transmitted from the transmitter is determined as P_{A} for each selected subframe.

At step S820, a maximum value and a minimum value of a pitch estimation range are decided based on the transmitting pitch.

At step S830, at least one candidate pitch in the pitch estimation range is estimated by using an open-loop pitch search operation of the G.723.1 for each selected subframe. That is, four candidate pitch groups are estimated.

At step S840, a final pitch is searched around the estimated candidate pitch by using a closed-loop pitch search operation of the G.723.1 for each subframe in the G.723.1. In detail, the first candidate pitch group and the second candidate pitch group are selected to search for each subframe in a first frame of the G.723.1, the third candidate pitch group and the fourth candidate pitch group are selected to search for each subframe in a second frame of the G.723.1.

At each step S730 and S830, when the candidate pitch in the pitch estimation range is estimated by using the open-loop pitch search operation for each selected subframe, an index “j” is obtained to maximize a following equation 2.

$${C}_{OL} ( j ) = \frac{{[ {\sum }_{n = 0}^{N} {s}_{w} ( n ) \cdot {s}_{w} ( n - j ) ]}^{2}}{{\sum }_{n = 0}^{N} {s}_{w} ( n - j ) \cdot {s}_{w} ( n - j )} , {P}_{min} \leq j \leq {P}_{max} \qquad [ Equation 2 ]$$

Where, s_{w} is a perceptual weighted speech signal; N is a size of subframe; Pₘᵢₙ is a minimum value of the pitch estimation range; and Pₘₐₓ is a maximum value of the pitch estimation range.

That is, in the present invention (the pitch conversion method) the index “j” is obtained to maximize C_{OL} and at least one “j” is estimated as a candidate pitch for each selected subframe.

A complexity of the pitch conversion method in accordance with the present invention is decided by the pitch estimation range represented as Pₘᵢₙ and Pₘₐₓ, and the pitch estimation range is determined by considering corresponding characteristics of a receiver.

Lastly, at each step S740 and S840, in searching step of the final pitch (a closed-loop pitch) by using the closed-loop pitch search operation, a final pitch for each subframe is searched around the estimated candidate pitch “j”.

The pitch conversion method, which is suggested in the present invention, can be realized as a program and stored in a computer-readable recording medium, such as a CD-ROM, a RAM, a ROM, floppy disks, hard disks and magneto-optical disks.

Since the process can be easily implemented by people skilled in the art where the present invention belongs, further description on it will not be provided herein.

As describe above, the present invention can reduce a complexity of a transcoder and improve a speech quality of a decoded speech based on characteristics of encoder in a transmitter and a decoder in a receiver to the transcoder.

The present application contains subject matter related to Korean patent application No. 2004-0088460, filed with the Korean Patent Office on Nov. 2, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A pitch conversion method for reducing a complexity of a transcoder, the method comprising:
classifying plural frames transmitted from a transmitter into frame units, each having a predetermined number of frame;
recognizing a transmitting pitch included in the frame units;
deciding a pitch estimation range based on the transmitting pitch;
estimating at least one candidate pitch in the pitch estimation range by using a open-loop pitch search operation; and
searching a final pitch around the estimated candidate pitch by using a closed-loop pitch search operation.

2. The method as recited in claim 1, wherein the classifying plural frames includes:
separating each frame unit into two frame block, each having plural subframes; and
selecting at least one of the plural subframes in each frame block.

3. The method as recited in claim 2, wherein the pitch conversion is performed from a G.723.1 to an Adaptive Multi-Rate (AMR).

4. The method as recited in claim 3, wherein the frame unit includes two frames, each frame having 4 subframes.

5. The method as recited in claim 4, wherein 3 subframes are selected among the 4 subframes in each frame.

6. The method as recited in claim 5, wherein a first subframe, a second subframe and a fourth subframe are selected in one frame, and a first subframe, a third subframe and a fourth subframe are selected in the other frame.

7. The method as recited in claim 2, wherein the pitch conversion is performed from an AMR to a G.723.1.

8. The method as recited in claim 7, wherein the frame unit includes three frames, each frame having 4 subframes.

9. The method as recited in claim 8, wherein a first subframe and a fourth subframe are selected in a first frame, and a third subframe is selected in a second frame, and a second subframe is selected in a third frame.

10. The method as recited in claim 1, wherein, in estimating at least one candidate pitch, an index of “j” is obtained to maximize an equation in the pitch estimation range, the equation being expressed as:
$${C}_{OL} ( j ) = \frac{{[ {\sum }_{n = 0}^{N} {s}_{w} ( n ) \cdot {s}_{w} ( n - j ) ]}^{2}}{{\sum }_{n = 0}^{N} {s}_{w} ( n - j ) \cdot {s}_{w} ( n - j )} , {P}_{min} \leq j \leq {P}_{max} ,$$
where, s_{w} is a perceptual weighted speech signal; N is a size of subframe; Pₘᵢₙ is a minimum value of the pitch estimation range; and Pₘₐₓ is a maximum value of the pitch estimation range.

11. The method as recited in claim 1, wherein, in deciding the pitch estimation range, a minimum value of the pitch estimation range (Pₘᵢₙ) and a maximum value of the pitch estimation range (Pₘₐₓ) are decided by using an equation for determining the pitch estimation range based on characteristics of a encoder in the transmitter and a decoder in a receiver of the transcoder, the equation being expressed as:
Pₘᵢₙ=P_{G}−1, Pₘₐₓ=P_{G}+1, case: G.723.1 to AMR
Pₘᵢₙ=P_{A}−3, Pₘₐₓ=P_{A}+3, case: AMR to G.723.1,
where, P_{G} is a transmitting pitch transmitted from a G723.1; and P_{A} is a transmitting pitch transmitted from an AMR.

12. The method as recited in claim 1, wherein, in searching the final pitch, the final step is obtained for each subframes by using the candidate pitch.

13. A computer readable record medium for storing of a program for executing a pitch conversion method for reducing complexity of transcoder, the method comprising:
classifying plural frames transmitted from a transmitter into frame units, each having a predetermined number of frame;
recognizing a transmitting pitch included in the frame units;
deciding a pitch estimation range based on the transmitting pitch;
estimating at least one candidate pitch in the pitch estimation range by using a open-loop pitch search operation; and
searching a final pitch around the estimated candidate pitch by using a closed-loop pitch search operation.
